(19) United States
(12) Patent Application Publication
(10) Pub. No.: US 2026/0220612 A1
(43) Pub. Date: Jul. 30, 2026

(54) Flexible Schedule Processing

(71) Applicant: PagerDuty, Inc., San Francisco, CA (US)

(72) Inventors: Irena Grabovitch - Zuyev, Quispamsis (CA); Madhuri Jakkaraju, Frisco, TX (US); Ken Chavis Choate, The Woodlands, TX (US); Bill Charles Barksdale, Kennett Square, PA (US)

(21) Appl. No.: 19/039,261

(22) Filed: Jan. 28, 2025

(51) Int. Cl. G06Q 10/1093

(52) U.S. Cl. CPC G06Q 10/1093

(57) ABSTRACT

The present disclosure provides a method, non-transitory computer-readable medium, and apparatus for processing schedule files. A schedule file in spreadsheet format is received. A first large language model prompt is transmitted to a first large language model to interpret a legend in the schedule file, resulting in a first candidate schedule characteristic. A second large language model prompt based on the schedule and candidate schedule characteristic is transmitted to a second large language model to generate a standardized schedule conforming to a pre-determined schema interpretable by a first application. An application-specific schedule is updated based on the standardized schedule. Data corresponding to the application-specific schedule is transmitted to a client for display. The method may further include transmitting additional prompts to identify schedule characteristics, generating confidence scores, and requesting clarifications.

### TECHNICAL FIELD

This disclosure relates generally to computer operations and more particularly, but not exclusively, to flexible schedule processing.

### SUMMARY

According to an aspect of the present disclosure, a method is provided. The method includes receiving a schedule file in a spreadsheet format, the schedule file including a schedule. The method further includes transmitting a first large language model prompt to a first large language model, the first large language model prompt configured to, when processed by the first large language model, cause the first large language model to interpret a legend in the schedule file. The method also includes receiving a first candidate schedule characteristic from processing the first large language model prompt with the first large language model. Additionally, the method includes transmitting a second large language model prompt to a second large language model, the second large language model prompt is based on the schedule and candidate schedule characteristic and is configured to, when processed by the second large language model, cause the second large language model to generate a standardized schedule conforming to a pre-determined schema that is interpretable by a first application. The method further includes updating an application-specific schedule based on the standardized schedule, and transmitting data corresponding to the application-specific schedule to a client for display.

According to another aspect of the present disclosure, a non-transitory computer-readable medium storing instructions is provided. When executed by one or more processors, the instructions cause the one or more processors to perform operations comprising receiving a schedule file in a spreadsheet format, the schedule file including a schedule. The operations further include transmitting a first large language model prompt to a first large language model, the first large language model prompt configured to, when processed by the first large language model, cause the first large language model to interpret a legend in the schedule file. The operations also include receiving a first candidate schedule characteristic from processing the first large language model prompt with the first large language model. Additionally, the operations include transmitting a second large language model prompt to a second large language model, the second large language model prompt is based on the schedule and candidate schedule characteristic and is configured to, when processed by the second large language model, cause the second large language model to generate a standardized schedule conforming to a pre-determined schema that is interpretable by a first application. The operations further include updating an application-specific schedule based on the standardized schedule, and transmitting data corresponding to the application-specific schedule to a client for display.

According to another aspect of the present disclosure, an apparatus is provided. The apparatus includes one or more processors and memory storing instructions that, when executed by the one or more processors, cause the apparatus to receive a schedule file in a spreadsheet format, the schedule file including a schedule. The instructions further cause the apparatus to transmit a first large language model prompt to a first large language model, the first large language model prompt configured to, when processed by the first large language model, cause the first large language model to interpret a legend in the schedule file. The instructions also cause the apparatus to receive a first candidate schedule characteristic from processing the first large language model prompt with the first large language model. Additionally, the instructions cause the apparatus to transmit a second large language model prompt to a second large language model, the second large language model prompt is based on the schedule and candidate schedule characteristic and is configured to, when processed by the second large language model, cause the second large language model to generate a standardized schedule conforming to a pre-determined schema that is interpretable by a first application. The instructions further cause the apparatus to update an application-specific schedule based on the standardized schedule, and transmit data corresponding to the application-specific schedule to a client for display.

These and other aspects of the present disclosure are disclosed in the following detailed description of the embodiments, the appended claims and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 shows components of one embodiment of a computing environment for flexible schedule processing.

FIG. 2 shows one embodiment of a client computer.

FIG. 3 shows one embodiment of a network computer that may at least partially implement one of the various embodiments.

FIG. 4 illustrates a logical architecture of a system for flexible schedule processing.

FIG. 5 illustrates extensions to the logical architecture of the system for flexible schedule processing.

FIG. 6 illustrates layers of an application-specific schedule.

FIG. 7 shows an example user interface displaying multiple schedule layers.

FIG. 8 illustrates example schedule formats that may be provided in a schedule file.

FIG. 9 shows a flowchart of a technique for processing schedule files.

### DETAILED DESCRIPTION

In modern computing environments, organizations increasingly rely on complex scheduling systems to manage various aspects of their operations, from employee shifts to resource allocation. These systems often involve sophisticated software applications that generate schedules according to data obtained from multiple sources including by obtaining input through a user interface. However, traditional scheduling systems face significant technical challenges in utilizing schedule information that may already exist elsewhere in different formats and platforms.

One challenge with conventional scheduling technologies is a lack of flexibility in processing diverse schedule formats. Many existing systems are designed to work with specific file types or data structures, limiting their ability to integrate scheduling information from various sources seamlessly. This rigidity may result in organizations maintaining multiple scheduling systems or resorting to manual data entry and reconciliation processes, which can be time-consuming, costly and error-prone.

Additionally, the consistent interpretation of schedule data, especially when dealing with different time formats, shift codes, or organizational conventions, poses significant technical hurdles for automated systems. Format conversion in particular is a difficult technical problem to solve. For example, changes in or deviations from expected formatting or content of schedules may cause import routines to fail, resulting in wasted computing resources and delays in updating schedules. Handling large number of possible formats may require implementing a substantial number of configuration options, required definitions, and other bespoke capabilities which increases complexity, maintenance, and training requirements. In some cases, scheduling systems may not be used as intended due to the complexity of setting up or maintaining schedules, which may result, for example, in other automated systems not working as intended due to a lack of use or mis-use of the scheduling system.

Another technical issue arises from the need to maintain consistency and accuracy across different scheduling layers and applications. Organizations may employ multiple scheduling tools for different departments or functions. Certain departments and functions may resist using a prescribed schedule format or technique which may lead to disconnected shadow systems for scheduling. For example, spreadsheets may be utilized with ad-hoc formats to coordinate resource scheduling. Current solutions may not be capable of effectively or automatically making updates and resolving conflicts across these systems and scheduling approaches, leading to discrepancies and inefficiencies in resource allocation and management.

Implementations of this disclosure address problems such as these by providing a flexible schedule processing system that interprets diverse schedule formats using machine learning techniques. A schedule file may be received in a spreadsheet format. A spreadsheet format file includes excel (XLS), comma separated value (CSV) and other files containing data in a structured format having rows and columns of data. An iterative process using multiple large language model prompts (also referred to as prompts) and large language model invocations based on the prompts processes the schedule information. In some aspects, a first large language model prompt may be transmitted to a first large language model to interpret a legend in the schedule file. The system may then receive a candidate schedule characteristic from processing the first large language model prompt with the first large language model.

As used herein, the term “large language model” refers to a machine learning model trained on a vast amount of data that, when provided with a prompt, will produce an output based on that prompt. For example, a large language model may be implemented with a transformer-based neural network architecture. A typical implementation of such a large language model will have millions, billions, or trillions of weights that are utilized when processing input through the model. The weights may be determined using a training process where training data is processed through the neural network to produce an output. A loss function is used to compare the output to an expected output (according to the training data) in order to incrementally update the weights as the training data is incrementally processed by the neural network. Training may involve processing terabytes or petabytes of training data using teraFLOPS (floating point operations) or petaFLOPS of compute to do so. To infer an output sequence by processing an input sequence through a large language model may require gigabytes of memory and gigaFLOPS of compute.

In some implementations, a single large language model may be used for multiple processing steps (e.g., including the first, second, and third large language models referenced herein), while in other cases, separate large language models may be employed for different tasks such as legend interpretation, schedule analysis, and standardization. A large language model may be implemented locally, on-premises, or on a cloud-based computing resource. A large language model may also be provided as a service. For example, a large language model may be accessed by invoking an application programming interface (API) provided by a third-party service provider which then provides the output generated by the large language model.

The system may further transmit a second large language model prompt, based on the schedule and candidate schedule characteristic, to a second large language model. For example, the second large language model prompt may include the schedule and candidate schedule characteristic as context. This prompt may be configured to cause the second large language model to generate a standardized schedule conforming to a pre-determined schema that is interpretable by a first application. As used herein, a “pre-determined schema” may be implemented as a structured format or data model that defines the organization and relationships of schedule information. For instance, the schema may specify fields for employee identifiers, shift times, and job roles. For example, the schema may be implemented using a JavaScript Object Notation (JSON) based format.

In some implementations, the system may determine whether candidate schedule characteristic(s) have been correctly identified. If it is determined that the candidate schedule characteristic(s) may not have been correctly identified (e.g., based on a certain confidence level or threshold), then a request for clarification may be provided through a user interface to obtain feedback indicating that the candidate schedule characteristic is correct, or if not, what should be changed.

The term “organization” or “managed organization” as used herein refers to a business, a company, an association, an enterprise, a confederation, or the like.

The term “responder,” as used herein, can refer to a person or entity, represented or identified by persons, who may be responsible for responding to an event associated with a monitored application or service. A responder is responsible for responding to one or more notification events. For example, responders may be members of an IT team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

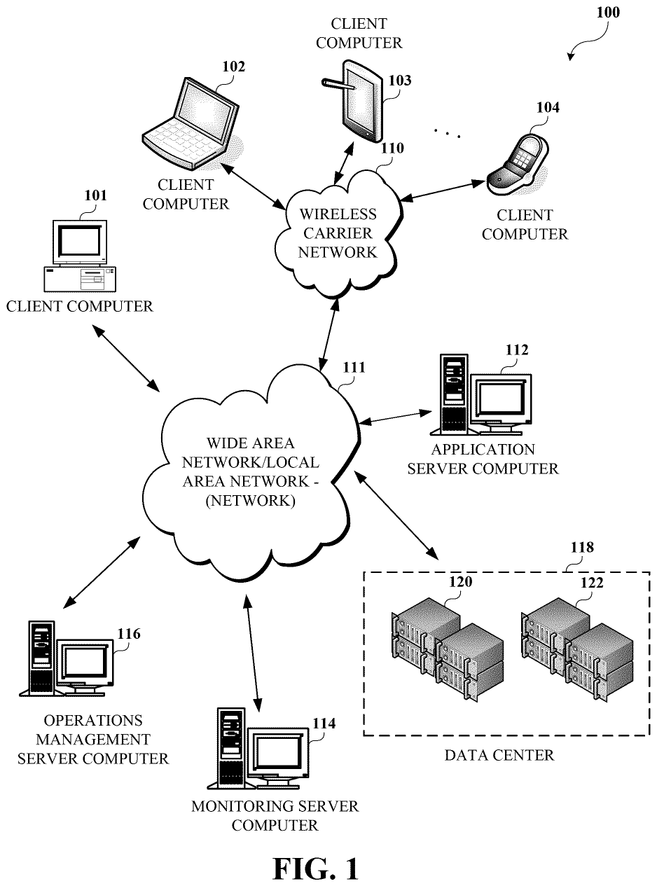

FIG. 1 shows components of one embodiment of a computing environment 100 for flexible schedule processing. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include a portable computing device capable of receiving and sending a message over a network, such as the network 111, the wireless network 110, or the like. The client computers 102-104 may also be described generally as client computers that are configured to be portable. Thus, the client computers 102-104 may include a portable computing device capable of connecting to another computing device and receiving information. Such devices include portable devices such as cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include a computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over a wired and/or wireless network. Such devices may include a capability to access and/or otherwise communicate over a network such as the network 111 and/or the wireless network 110. Moreover, the client computers 102-104 may access various computing applications, including a browser, or other web-based applications.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring one or more of servers 112, 114, or 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2 G), 3rd (3 G), 4th (4 G), 5th (5 G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can be implemented using a variety of different communication methods by which information may travel between computing devices.

Additionally, communication media may include computer-readable instructions, data structures, program modules, or other transport mechanisms and may be implemented using a variety of information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

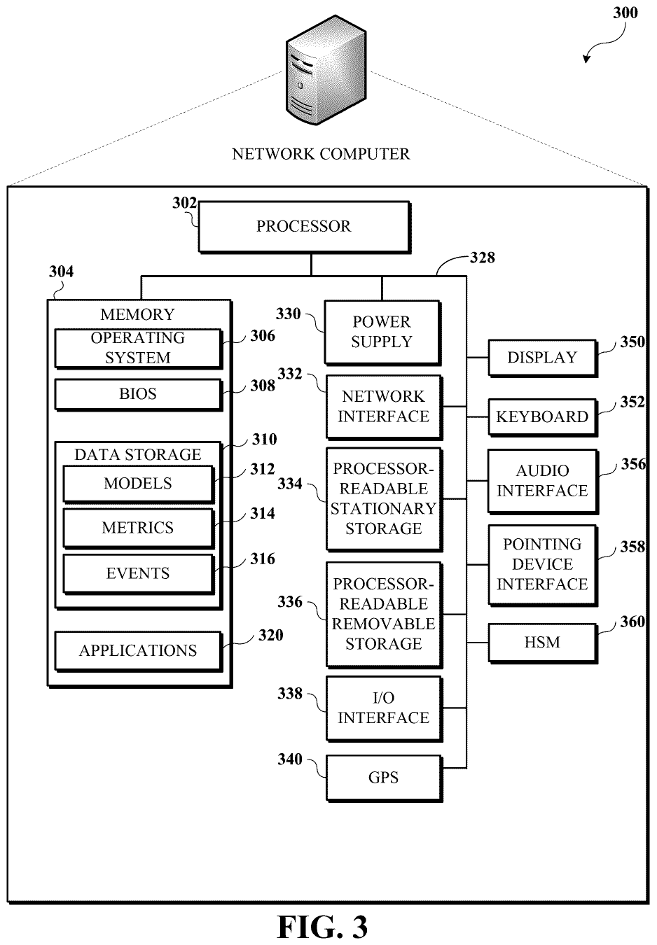

The operations management server computer 116 may include a network computer or cloud-based computing resource usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents one or more computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the servers 112, 114, 116 are not to be construed as being limited to a single environment, and other configurations, and architectures are also contemplated. Servers 112, 114, 116 may employ processes such as described below in conjunction with at least some of the figures discussed below to perform at least some of its actions.

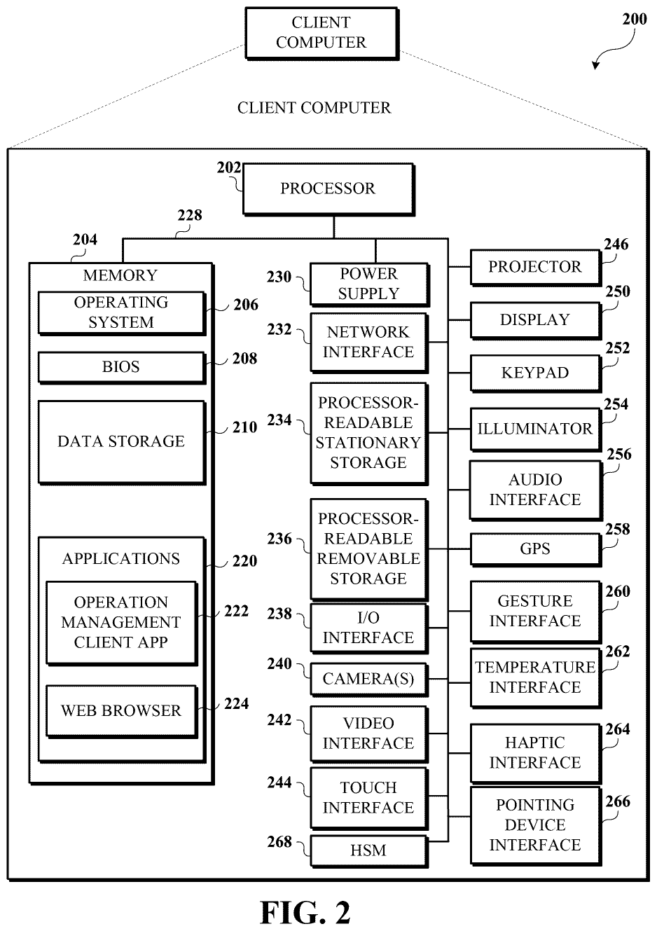

FIG. 2 shows one embodiment of a client computer 200. The client computer 200 may include components different than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 224 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include components different than those shown in FIG. 3. The network computer 300 may implement, for example, the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Inc.'s IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for generating smart incident status updates using generative artificial intelligence. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, which include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces as well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 110 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

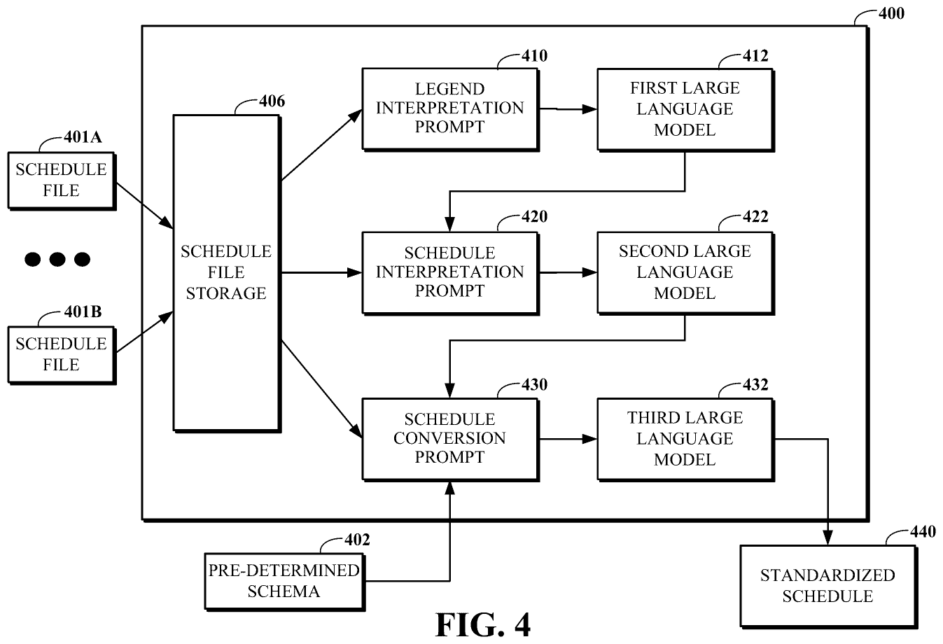

FIG. 4 illustrates a logical architecture of a system 400 for flexible schedule processing. The system 400 may include various components and processes that work together to interpret, analyze, and standardize schedule information from different input formats. System 400 may be implemented on or using one or more of the computing devices such as those described above with respect to FIG. 1 or 3, such as servers 112, 114, and 116, or network computer 300.

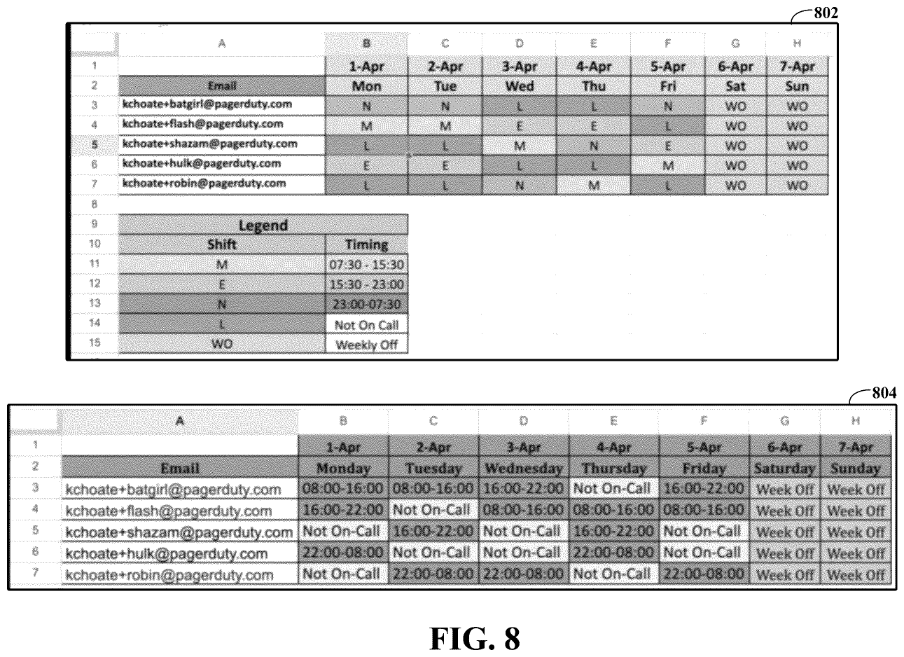

In some implementations, system 400 may take as input schedule files 401A and 401B. These schedule files may represent different formats or structures of schedule information that the system is designed to process. For example, schedule file 401A may be an excel spreadsheet containing employee shift information, while schedule file 401B may be a comma separated (CSV) text file listing on-call rotations. In other implementations, the schedule files may include other time-based scheduling information. The schedule files, for example, may include data representing a schedule and data representing a legend. Examples of schedule files are shown and described with respect to FIG. 8.

System 400 may obtain the schedule files and utilize a file storage 406 to store and manage the schedule files. In some aspects, the file storage 406 may be a database system, a cloud storage solution, or a local file system. The file storage 406 may provide capabilities such as version control, access management, and data backup. The mechanism for obtaining the schedule files may vary depending on the implementation. For example, the schedule file may be provided or uploaded through a user interface, obtained from a predetermined storage location external to the system 400, uploaded to storage 406 (e.g., through a file system interface such as SAMBA or network file system (NFS), or some combinations thereof.

A pre-determined schema 402 may be used by the system 400. This schema may define the structure and format of the standardized schedule 440 that the system is designed to produce. In some implementations, the pre-determined schema 402 may be a JSON or XML schema defining the fields and relationships of schedule data. Alternatively, it may be a database schema or a custom data structure optimized for schedule processing.

The system 400 may employ a legend prompt 410 to initiate the interpretation of schedule file legends. This prompt may be a set of instructions or queries designed to instruct a large language model to extract information from a legend in the schedule file. For example, the legend prompt 410 may include natural language instructions to identify and extract shift codes, time formats, or other information defined by a legend in the schedule file. In some cases, the legend prompt 410 may be dynamically generated based on the contents of the input schedule file.

A first large language model 412 may be utilized to process the legend prompt 410 and interpret the schedule file legend. For example, the legend prompt may be transmitted to the first large language model 412 for processing to produce a candidate schedule characteristic describing a characteristic of the schedule according to the legend. For example, the candidate schedule characteristic may indicate a mapping between a shift code and a shift time range, an indicator that indicates that a resource is on paid time off (PTO), out sick or is otherwise not schedulable, a time range of a shift, a time range of the schedule, or combinations thereof. In some implementations, the first large language model 412 is a general-purpose large language model. In some implementations, this may be a large language model trained or fine-tuned on various schedule formats and legends. The first large language model 412 may employ natural language processing techniques to understand and extract relevant information from the legend. Some implementations may use specialized machine learning models focused specifically on schedule interpretation. Some implementations may use a combination of rule-based systems and machine learning models for legend interpretation.

The system 400 may include a schedule interpretation prompt 420 that is based on the information extracted from the legend. This prompt may be designed to cause the large language model to identify a candidate schedule characteristic representing information in a schedule included in the schedule file. For instance, the interpretation prompt 420 may include instructions for identifying shift patterns, employee assignments, or time off requests within the schedule. Candidate schedule characteristics obtained by processing the legend interpretation prompt 410 through the first large language model 412 may be included in the schedule interpretation prompt 420 in order to provide additional context for the second large language model 422. In some implementations, the interpretation prompt 420 may be customized based on the specific needs or operational patterns of the organization using the system.

A second large language model 422 may be employed to process the schedule interpretation prompt 420 and analyze the schedule data to produce candidate schedule characteristic(s). For example, the schedule interpretation prompt 420 may be transmitted to the second large language model 422 for processing. In some implementations, the second large language model 422 is a general-purpose large language model. In some implementations, the model may be trained or fine-tuned to identify and extract certain information from a schedule, such as user information, across various schedule formats. In some aspects, the second language model 422 may use techniques such as pattern recognition, sequence analysis, or graph-based representations to interpret the schedule. Some implementations may use a combination of rule-based systems and machine learning models for schedule interpretation.

The system 400 may incorporate a schedule conversion prompt 430 that is based on the previously obtained candidate schedule characteristic(s) and is designed to cause a third large language model 432 to convert the schedule into a standardized format. The prompt may include a description of the pre-determined schema 402 and instructions on how to map certain types of schedule information to a format consistent the pre-determined schema 402. The prompt may include descriptions of how to utilize certain types of candidate schedule characteristics when mapping and converting the schedule to the standardized format. For example, the conversion prompt 430 may specify how to handle different time formats, shift definitions, or employee identifiers across various input formats. The prompt may include the contents of the associated schedule file including a schedule and a legend included in the schedule file.

For example, schedule conversion prompt 430 may include, in some implementations, the following text: ““The provided schedules use the following legend: {response_subtask1}, and cover the following users: {response_subtask2}. These are the schedules you need to transform: {response_subtask3}, while following the format {format}” where {response_subtask1} includes candidate schedule characteristics identified from 410 and 412, {response_subtask2} includes candidate schedule characteristics describing users as identified from 420 and 422, {response_subtask3} includes the schedule from the schedule file 401A or 401B, and {format} includes the pre-determined schema 402.

A third language model 432 may be utilized to process the schedule conversion prompt 430 and generate the standardized schedule. For example, the schedule conversion prompt 430 may be transmitted to the third large language model 432 for processing. In some implementations, the third large language model 432 is a general-purpose large language model. In some implementations the model may be trained or fine-tuned on various permutations of input schedule formats, legend formats, candidate schedule characteristics, pre-determined schemas, and standardized formats, to provide a model that is better capable of performing the requested transformations. In some implementations, the third language model 432 may employ techniques such as sequence-to-sequence transformation or structured prediction to generate the standardized output. Alternative embodiments may use large language model generated templates or rules to generate the standardized schedule.

The system 400 may produce a standardized schedule 440 as its output. For example, the standardized schedule may be produced by third large language model 432 processing schedule conversion prompt 430. This standardized schedule may conform to the pre-determined schema 402. In some aspects, the standardized schedule 440 may be a machine-readable format such as JSON or XML, facilitating easy integration with other systems. For example, the pre-determined schema and the standardized schedule may be compatible for use with an application-specific schedule. For example, the application-specific schedule may be a schedule used in an operations management system, such as provided using operations management server 116.

In some implementations, candidate schedule characteristics may include shift definitions (e.g., 7 to 11 or M for morning), schedule periodicity (e.g., daily, weekly, monthly schedules), schedule duration (e.g., 1 week, 2 weeks, 1 month), identifiers (e.g., paid time off (PTO), shift, day identifiers, holidays), whether an explicit legend exists, user identifiers, or combinations thereof. Candidate schedule characteristics may relate or refer to the schedule as a whole or particular aspects of a schedule (e.g., a particular individual included in the schedule, a day or other time unit of the schedule, a schedule category, or the like). For example, a schedule may include shifts associated with a particular information technology infrastructure (e.g., a group of shifts for an east infrastructure and a group of shifts for a west infrastructure).

In some implementations, the system 400 may include feedback loops or iterative processes to improve the accuracy of the output. For example, the system may iteratively process similar prompts, such as the legend prompt to produce candidate schedule characteristics that are added to the prompt that are then used to iteratively generate new and update existing candidate schedule characteristics. For example, the addition of candidate schedule characteristics to a prompt may enable the large language model to identify sets of candidate schedule characteristics that are not internally consistent, indicating that modifications or deletions are needed, or extrapolate additional candidate schedule characteristics from those provided. Additionally, the system may learn from user corrections or validations to improve its performance over time.

In some implementations, the system 400 may utilize a different ordering or usage of components than what is depicted in FIG. 4 (e.g., where prompt 410 is processed first, prompt 420 is processed second (and may be based on outputs from processing prompt 410), and prompt 430 is processed third (and may be based on outputs from processing prompts 410 and/or prompt 420). For example, multiple prompts may be processed, the outputs may be used in a schedule conversion prompt such as described with respect to schedule conversion prompt 430. Other permutations of prompt chains (e.g., where multiple prompts are generated in order based on output from processing one or more prior prompts) are possible, depending on the implementation.

The system 400 may be designed to handle a wide variety of schedule formats. It may be capable of processing schedules for different industries, such as healthcare, retail, manufacturing, information technology or service sectors, each with their unique scheduling requirements and conventions. The flexibility of the language model-based approach allows the system to adapt to new schedule formats without requiring extensive reprogramming.

In some implementations, system 400 may be able to utilize schedule files in other structured or unstructured file formats such as JavaScript Object Notation (JSON), eXtensible Markup Language (XML), or plan text (TXT) files.

Different implementations of system 400 utilizing fewer, additional or different components are possible. For example, fewer or additional prompts may be utilized which may be processed by fewer or additional large language models. For example, a prompt may be used to detect whether a legend is included in a schedule file and based on the result of processing that prompt, a determination may be made whether to process legend interpretation prompt 410. For example, in some implementations, if a legend is not present in a schedule, processing may stop and a message returned indicating that a standardized schedule cannot be generated because there is no legend. Alternatively, a request for legend information could be transmitted to a client device for presentation in a user interface to collect legend information that can then be transmitted to and received by system 400 for further processing (e.g., using legend information prompt 410). In some implementations, the schedule file may be examined to determine whether it is in the form of a spreadsheet, whether it includes a recognizable schedule, or a combination thereof. In such implementations, if a spreadsheet or schedule is not detected, processing of that schedule file may cease and an error may be returned indicating that the provided schedule file cannot be processed by system 400.

In some cases, system 400 may be utilized in order to populate specialized scheduling layers instead of staff or resource schedules. For example, in such an implementation, a schedule file may be in an spreadsheet or iCAL format and may include a schedule of unavailability for staff or resources (e.g., a time-off calendar).

In some cases, a single prompt may be used to process a schedule file and produce a standardized schedule output. For example, a single prompt may be structured to instruct an LLM to perform multiple tasks when interpreting the input, for example, to interpret the legend first and then utilize the result of that interpretation when generating the standardized schedule.

The following is one example of a prompt that may be used:

The agent receives a schedule in CSV format.
The schedule may include a legend to be used to interpret the schedule.
Your goal is to return the same schedule in a JSON format.
Include ALL the shifts from the CSV schedule for each team member.
This is the expected output format:

{{
“rendered_schedule_entries”: [
{{
“user name”: “User1 Name”
“start”: “2024-06-01T16:30”,
“end”: “2024-06-02T02:00”
}},
{{
“user name”: “User2 Name”
“start”: “2024-06-05T16:30”,
“end”: “2024-06-06T02:00”
}}
]
}}
Schedule in CSV format: {schedule}
Schedule in JSON format:
{{
“schedule”: {{
“custom_layer”: {{
“rendered_schedule_entries”: [
{{“start”: “2024-06-01T16:30”, “end”: “2024-06-02T02:00”, “user”: {{“name”: “User1 Name”,
“email”:
“abc@test.com”}},
{{“start”: “2024-06-05T16:30”, “end”: “2024-06-06T02:00”, “user”: {{“name”: “User2
Name”}},
{{“start”: “2024-06-06T16:30”, “end”: “2024-06-09T18:00”, “user”: {{“id”: “PKFLOYW”}}}}
]
}}
}}
}}

The following is an example of another prompt that may be used:

The agent is provided with a schedule in CSV form, which might contain a legend for interpreting it.
The objective is to convert this schedule into JSON format, ensuring that ALL shifts for each team member are included.
If a legend is provided, it should be utilized to determine the shift hours or to discern if the user is not on call, or if it's a weekend or holiday.
No shifts should be added if the user is not on call.
This is the expected output format:

{{
“schedule”: {{
“custom_layer”: {{
“rendered_schedule_entries”: [
{{“start”: “2024-06-01T16:30”, “end”: “2024-06-02T02:00”, “user”: {{“name”: “User1 Name”,
“email”:
“abc@test.com”}},
{{“start”: “2024-06-05T16:30”, “end”: “2024-06-06T02:00”, “user”: {{“name”: “User2
Name”}},
{{“start”: “2024-06-06T16:30”, “end”: “2024-06-09T18:00”, “user”: {{“id”: “PKFLOYW”} } } }
]
}}
}}
}}
### EXAMPLE
Schedule in CSV format:
,10-Jun, 11-Jun, 12-Jun, 13-Jun, 14-Jun
Email, Tue, Wed, Thu, Fri,Sat
kc@gmail.com,M,N,L,E,WO
,,,,,,,
Legend,,,,,,,
Shift, Timing,,,,,,
M,07:30 - 15:30,
E,15:30 - 22:00,,,,,,
N,22:00-07:30,,,,,,
L, Not On-Call,,,,,,
WO, Weekend Off,,,,
Schedule in JSON format:
{{
“schedule”: {{
“custom_layer”: {{
“rendered_schedule_entries”: [
{{“start”: “2024-06-10T07:30”, “end”: “2024-06-10T15:30”, “user”: {{“email”:
“kc@gmail.com”}},
{{“start”: “2024-06-11T22:00”, “end”: “2024-06-12T07:30”, “user”: {{“email”:
“kc@gmail.com”}},
{{“start”: “2024-06-13T15:30”, “end”: “2024-06-13T22:00”, “user”: {{“email”:
“kc@gmail.com”}}}}
]
}}
}}
}}
###
Convert this schedule into JSON format:
Schedule in CSV format: {schedule}
Schedule in JSON format:

The use of a single prompt or multiple prompts may, in some cases, be adaptively determined based on an assessment of a complexity of a schedule file, whether it includes a legend, other factors, or some combination thereof. The content of such prompts may also be adaptively determined based on prior determinations. In some cases, a prompt may be designed to determine whether a schedule file includes a valid schedule or a schedule appropriate for a particular application-specific schedule. Such a prompt may be processed to produce an output that determined whether the system 400 proceeds with converting the standardized schedule or not. For example, if the output of the prompt indicates that there is no valid schedule or the schedule is not appropriate for the application-specific schedule (e.g., the application-specific schedule relates to incident response and the provided schedule relates to a school calendar or restaurant staffing), then system 400 may stop processing the schedule file.

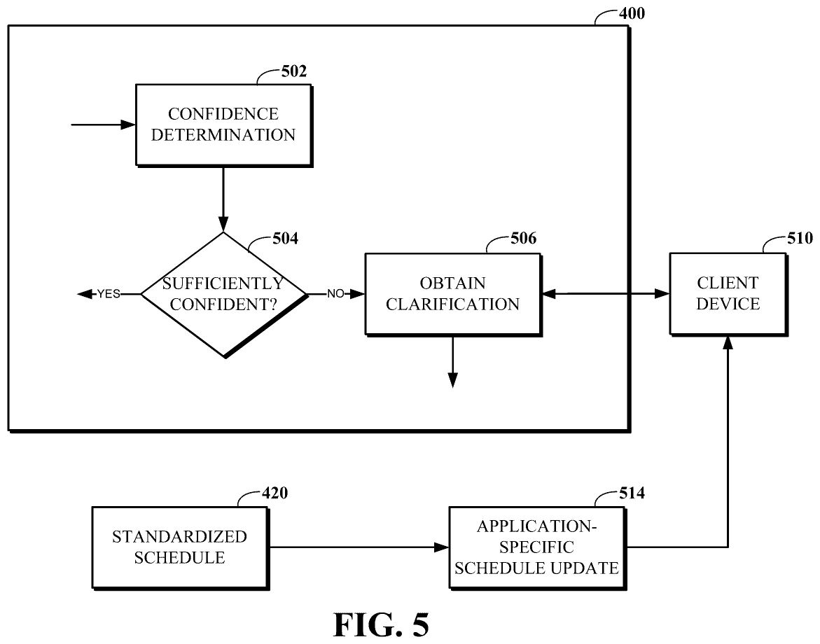

FIG. 5 illustrates an extended system 400 for processing and validating schedule information. FIG. 5 illustrates certain additional aspects that may be included in or be used in conjunction with system 400 in some implementations.

In some implementations, the system 400 may include a confidence determination 502. This component may be responsible for determining a confidence score of a candidate schedule characteristic. For example, this may be expressed as a numerical value within a particular numerical range. In some implementations, confidence determination 502 may be invoked for candidate schedule characteristics prior to generating a standardized schedule (e.g., by components 430, 432). The confidence determination 502 may utilize various metrics and algorithms to assess the reliability of the information extracted from the input schedule files. For example, it may consider factors such as the consistency of the interpreted data, the presence of ambiguous entries, or the similarity to previously processed schedules. In some cases, the confidence determination 502 may employ machine learning techniques to improve its accuracy over time based on prior determinations and feedback received in response to those determinations. In some implementations, one or more of the prompts described previously with respect to FIG. 4 may include instructions to generate a confidence score at the same time as a candidate schedule characteristic is generated by a large language model.

Following the confidence determination 502, the system 400 may incorporate a sufficiently confident check 504. This decision point may determine whether the candidate schedule characteristic meets a confidence threshold. The sufficiently confident check 504 may compare the confidence scores generated by the confidence determination 502 against configurable thresholds. In some implementations, these thresholds may be adjusted based on the specific requirements of the organization or the criticality of the scheduling process. For instance, a schedule relating to infrastructure having a high required service level may require a higher confidence threshold compared to a schedule relating to infrastructure having a lower required service level due to the potential impact of scheduling errors.

If the sufficiently confident check 504 indicates that the confidence score is adequate, the system 400 may generate a standardized schedule (e.g., using components 430 and 432 as described in FIG. 4). This path represents a scenario where the system 400 has high confidence in its interpretation of the input schedule data. In such cases, the system may bypass additional verification steps to streamline the processing workflow.

On the other hand, if the sufficiently confident check 504 determines that the confidence score is insufficient, obtain clarification 506 may obtain clarification of one or more candidate schedule characteristics. This component may obtain additional information or verification to resolve ambiguities or uncertainties in one or more of the candidate schedule characteristics. In some implementations, obtain clarification 506 may request confirmation that specific candidate schedule characteristics are accurate, and if not, request input correcting incorrect candidate schedule characteristic(s). In some implementations, obtain clarification 506 may be invoked in circumstances where an expected candidate schedule characteristic has not been generated, a legend was not found in the schedule file, a user was not able to be mapped to an application-specific user, or combinations thereof.

For example, obtain clarification 506 may request a mapping for a user id or e-mail found in the schedule file but not found in an application-specific list of users or for which no unambiguous match is found (e.g., if the schedule includes a first name that matches multiple users in the application). For example, obtain clarification 506 may request a definition for a string found in a schedule (e.g., “A” or “OFF”) for which no corresponding legend definition was found. For example, a user may be provided with a user interface including a message “What does ‘A’ mean in this cell?” with a text box for a response. In some implementations, a proposed interpretation may be provided and the user may be provided with a user interface requesting a binary yes/no response to confirm whether the proposed interpretation is correct (e.g., using a set of buttons).

In some implementations, candidate schedule characteristics may be verified on a sampling basis. In other words, a minimum number of candidate schedule characteristics may be verified regardless of or instead of a determination of a confidence score. The candidate schedule characteristics to be verified may be selected on a random basis, count basis (e.g., each 10^{th} characteristic, based on the lowest confidence score for the last x characteristics, some other metrics, or combinations thereof.

In some implementations, the obtain clarification 506 component may interface with a client device 510 to facilitate the clarification process. The client device 510 may represent various types of user devices, such as desktop computers, laptops, tablets, or smartphones. Through this interface, the system may cause the display of queries or requests for clarification to users who have knowledge of the scheduling process. In some cases, the client device 510 may provide a user interface for reviewing and confirming or correcting the candidate schedule characteristics.

The interaction between the obtain clarification 506 component and the client device 510 may take various forms. For instance, it may involve sending email notifications with embedded response options. In some implementations, the system may employ natural language processing techniques to generate human-readable questions and interpret free-text responses from users.

Once clarifications have been obtained, or if the initial confidence check passed, the system 400 proceeds to generate a standardized schedule 420. In some implementations, the standardized schedule 420 may be transmitted for display to the client device for confirmation that the standardized schedule was generated as expected. For example, this may be done prior to updating the application-specific schedule. In other implementations, the standardized schedule 420 may be requested by a user in order to facilitate transparency in the generative artificial intelligence transformation between the schedule file and the standardized schedule.

Following the generation of the standardized schedule 420, the standardized schedule 420 may be provided to an application that performs an application-specific schedule update 514. For example, the standardized schedule may be imported into an application that includes an application-specific schedule to update the application-specific schedule. For example, some application-specific schedules may have layers of scheduling information, and the standardized schedule may be imported to create or update a layer of the application-specific schedule. The import may be carried out using a file selection user interface component, by placing the standardized schedule in a file location monitored by the application for standardized schedules, using an application programming interface, other mechanisms, or combinations thereof.

In some cases, the application-specific schedule update 514 may trigger notifications or alerts to relevant stakeholders. For example, it may send email notifications to employees about schedule changes, update digital signage in workplaces, or generate reports for managers summarizing the latest scheduling information.

Data corresponding to the application-specific schedule may be transmitted to client device 510 for display after the application-specific schedule is updated. For example, if the standardized schedule is imported into a layer of the application-specific schedule, data relating to that new layer may be transmitted to client device 510 for display using a user interface.

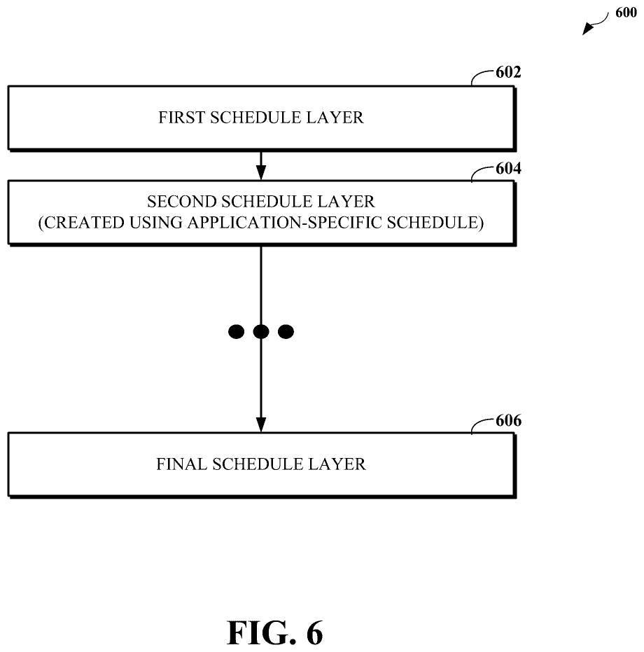

FIG. 6 illustrates layers 600 of an application-specific schedule. The layers 600 may represent different stages or levels of schedule processing, each building upon the previous layer to create a more refined schedule based on the various layers.

The first layer 602, labeled as “FIRST SCHEDULE LAYER,” may represent the initial schedule layer. In some implementations, this layer may correspond to the lowest priority schedule information. For example, the first layer 602 may include default or pre-populated schedule information from the application. In some implementations, the first layer 602 may represent a template or base schedule upon which subsequent layers are built.

The second layer 604, labeled as “SECOND SCHEDULE LAYER (CREATED USING APPLICATION-SPECIFIC SCHEDULE)” represents the schedule information imported or updated from the standardized schedule. Given that layer 604 is below layer 602, in some implementations, schedule information included in layer 604 may supersede information in layer 602.

The final layer 606, labeled as “FINAL SCHEDULE LAYER,” represents the combination of schedule information from prior layers. In some implementations, this layer may contain the fully processed, validated, and optimized schedule ready for distribution or implementation. The final layer 606 may incorporate all modifications, approvals, and refinements from previous layers. For example, layers 602 and 604 may be combined. Where there is a conflict between layers, in some implementations, lower layer information may be utilized.

Depending on the implementation, additional or fewer layers may be utilized, such as (but not limited to) between layers 604 and 606. In some implementations, a history of each layer may be maintained to permit the display of prior versions of layers and to permit the tracking of changes of layers. For example, if multiple version of a standardized schedule are provided to the application over time, those standardized schedules may be maintained in order to track the history of the schedule and attribute where changes in the schedule originated from.

In some implementations, a schedule layer may operate as an exclusionary layer. For example, a schedule file may include a schedule of resource or staff unavailability (e.g., a time off calendar). In such case, when a standardized schedule is generated based on the schedule file, it may create or update a schedule layer that operates to prevent the scheduling of particular staff or resources during a period of unavailability.

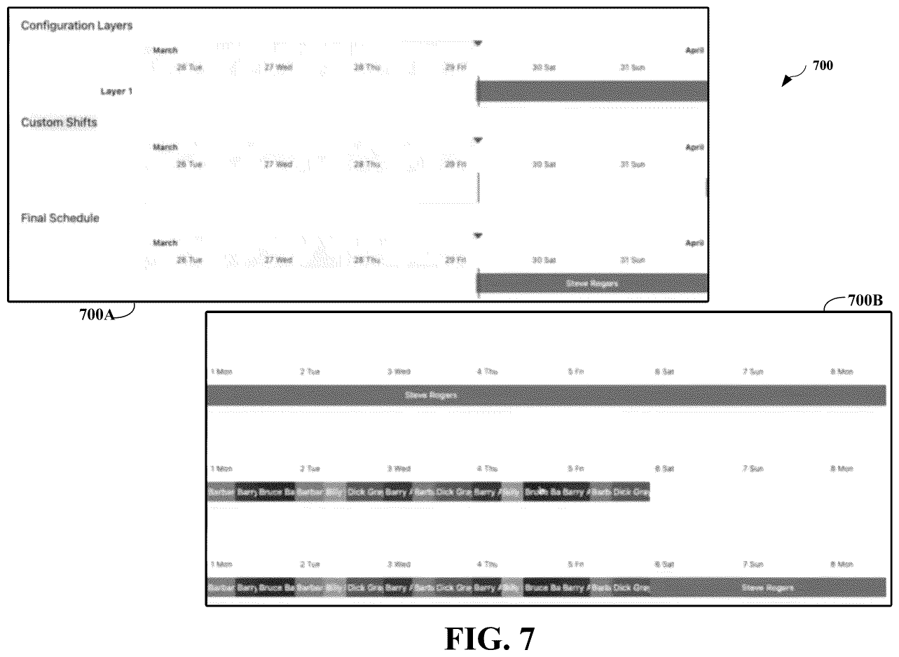

FIG. 7 illustrates a schedule user interface 700 that displays multiple schedule layers. The schedule user interface 700 may provide a visual representation of various layers of scheduling information simultaneously. FIG. 7 depicts schedule user interface 700 in a first section 700A and a second section 700B.

In some implementations, the schedule user interface 700 may present three or more distinct horizontal sections representing different schedule views. These sections may include a Configuration Layer at the top, a Custom Shifts Layer in the middle, and a Final Schedule Layer at the bottom. The schedule as depicted shows a schedule over two weeks, but the number of days or weeks shown may vary depending on the implementation. The user interface includes triangles and vertical lines showing a current time when the user interface is rendered.

The Configuration Layer may represent a base or initial schedule layer. In some aspects, this layer may display default shifts that will apply if not overridden by subsequent layers.

The Custom Shifts Layer, positioned in the middle of the schedule user interface 700, depicts shifts obtained from the import of a standardized schedule, such as described with respect to FIGS. 4, 5, and 9. For example, for Monday the first, the Custom Shift Layer depicts a shift for Barbara followed by a shift for Barry followed by a shift for Bruce.

The Final Schedule view, located at the bottom of the schedule user interface 700, may combine elements from both Configuration Layer and Custom Shifts Layer to present a final schedule. For example, schedule items included on the Custom Shifts Layer may overwrite any corresponding items in the Configuration Layer, leaving items in the Configuration Layer only when there are no scheduled items in the Custom Shifts Layer.

The schedule user interface 700 may utilize a timeline-based layout with consistent date alignment across all three layers. This alignment may allow for easy comparison and visualization of scheduling information across different layers. In some implementations, the interface may include vertical gridlines or date separators to enhance readability and facilitate precise schedule comparisons. The consistent timeline may also support features such as synchronized scrolling or zooming across layers, enabling users to focus on specific time periods while maintaining context across all views.

In some aspects, the schedule user interface 700 may incorporate interactive elements to enhance user experience and functionality. For example, users may be able to click or hover over specific shifts to view additional details, such as employee contact information or shift-specific notes. The interface may also include filtering options, allowing users to focus on specific departments, roles, or time periods. Alternative implementations may provide drag-and-drop functionality for making quick schedule adjustments or the ability to toggle between different view modes (e.g., daily, weekly, monthly) while maintaining the multi-layer structure.

FIG. 8 illustrates example schedule formats that may be processed by the system described in this disclosure. The figure presents two example schedule formats: an example schedule with explicit legend 802 and an example schedule without explicit legend 804. Each schedule format may be stored in a schedule file, such as in a Excel format file (.xls or .xlsx), comma separated file (.csv), or other spreadsheet formatted file format.

The example schedule with explicit legend 802 utilizes shift codes to denote different time periods, with an accompanying legend that explicitly defines the meaning of each code. For instance, the legend may define “M” as representing a morning shift from 07:30-15:30, “E” as an evening shift from 15:30-23:00, and “N” as a night shift from 23:00-07:30. In some cases, the legend may also include codes for special statuses, such as “L” for when staff are not on call or “WO” for weekly time off.

The legend in the example schedule with explicit legend 802 may, for example, be interpreted in connection with legend interpretation prompt 410 as described above with respect to FIG. 4. In some aspects, the system may be designed to automatically detect and parse such legends, using them as a key to interpret the rest of the schedule. The legend may contain additional information beyond shift times, such as department codes, skill level indicators, or special assignment designations.

The example schedule without explicit legend 804 presents an alternative approach to schedule representation. In this format, specific time ranges are used directly within the schedule, eliminating the need for a separate legend. For instance, instead of using a code like “M”, this format may display “08:00-16:00” directly in the schedule cell. Similarly, status indicators like “Not On-Call” and “Week Off” may be written out explicitly rather than using abbreviated codes. In such cases, the output from processing legend interpretation prompt 410 may result in a candidate schedule characteristic indicating that there is no legend or that there is an implicit legend. In the case of an implicit legend, aspects extracted from the schedule (e.g., “08:00-16:00”) may be identified as candidate schedule characteristics.

Both the example schedule with explicit legend 802 and the example schedule without explicit legend 804 may contain the same basic scheduling information, such as employee identifiers (e.g., email addresses) and a defined time period (e.g., a week from April 1 to April 7). The system may be designed to extract and standardize this common information regardless of the input format. For example, such information may be extracted as candidate schedule characteristics by processing schedule interpretation prompt 420 as described previously with respect to FIG. 4.

The schedule processing system may employ various techniques to handle the different formats illustrated in FIG. 8. For example, when processing the example schedule with explicit legend 802, the system may first analyze the legend to build a mapping of codes to shift times or statuses. This mapping may then be applied to interpret the main body of the schedule. In contrast, when processing the example schedule without explicit legend 804, the system may directly parse the time ranges and status descriptions, potentially using pattern recognition or natural language processing techniques.

The schedule formats illustrated in FIG. 8 may represent just two examples from a wide range of possible input formats that the system may be designed to handle. Other potential formats may include calendar-style layouts, Gantt chart representations, or even free-text descriptions of schedules.

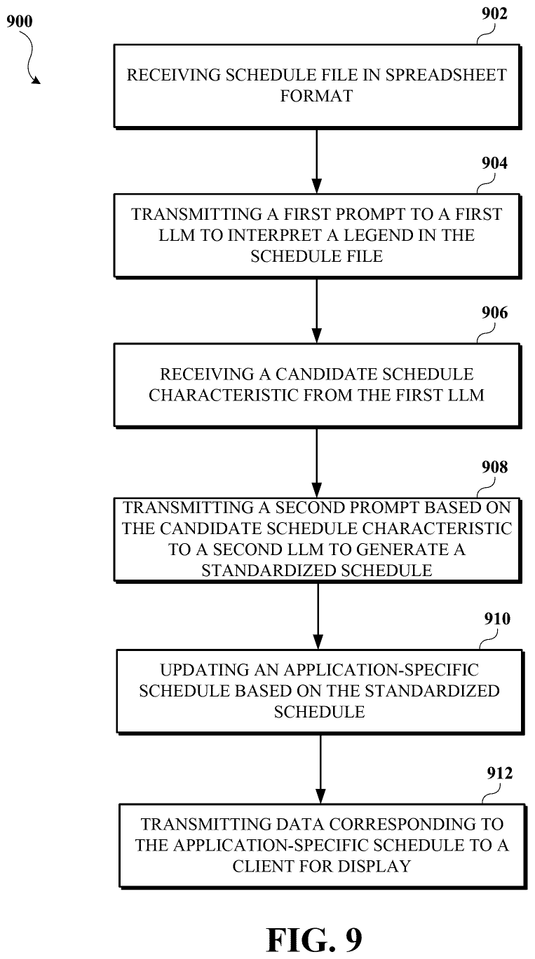

To further describe some implementations in greater detail, reference is next made to examples of techniques which may be performed by or using the systems as described herein. FIG. 9 is a flowchart of an example of a technique associated with flexible schedule processing. Technique 900 can be executed using computing devices, such as the systems, hardware, software, and data described herein. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations of the technique 900 can occur in various orders and/or concurrently. Additionally, other steps or operations not presented and described herein may be used. Furthermore, not all illustrated steps or operations may be required to implement a technique in accordance with the disclosed subject matter.

At 902, the technique 900 includes receiving a schedule file in a spreadsheet format. The schedule file can include a schedule and a legend. For example, a file storage system (e.g., the file storage 406 shown in FIG. 4) may receive and store a schedule file in a spreadsheet format. In some implementations, the schedule file may be in various formats such as CSV, XLS, or XLSX. The system may be capable of handling multiple input formats, including those with explicit legends (as shown in example schedule 802 in FIG. 8) or without explicit legends (as shown in example schedule 804 in FIG. 8).

At 904, the technique 900 involves transmitting a first large language model prompt to a first large language model (LLM) to interpret a legend in the schedule file. For instance, a first language model 412 (shown in FIG. 4) may process the schedule file to identify and interpret any legends present. In some aspects, this step may involve analyzing the structure of the spreadsheet to locate legend information, which may be positioned in various parts of the document. The first LLM may be fine-tuned on a wide variety of legend formats to enhance its interpretation capabilities.

At 906, the technique 900 includes receiving a first candidate schedule characteristic from processing the first large language model prompt with the first LLM. For example, the system may receive output from the first LLM that includes interpreted information about shift codes, time ranges, or other schedule-related data extracted from the legend. In some implementations, this step may also involve a confidence determination (e.g., using the confidence determination 502 shown in FIG. 5) to assess the reliability of the candidate schedule characteristic.

At 908, the technique 900 involves transmitting a second large language model prompt based on the candidate schedule characteristic and the schedule to a second LLM to generate a standardized schedule (e.g., using schedule conversion prompt 430 and third large language model 432 as described with respect to FIG. 4). For example, the prompt may include the schedule, candidate schedule characteristic(s) or transformations thereof. The prompt may also include a predetermined schema (e.g., the pre-determined schema 402 shown in FIG. 4). The second LLM may process the prompt to produce a standardized schedule according to the predetermined schema. The standardized schedule will include the shifts described in the schedule included in the schedule file but transformed into the predetermined schema which is machine-interpretable by an application.

At 910, the technique 900 includes updating an application-specific schedule based on the standardized schedule. For example, an application (e.g., using the application-specific schedule update 514 shown in FIG. 5) may import the standardized schedule information into the application. In some implementations, this step may involve creating or updating a layer of schedule information (e.g., layer 602 as described with respect to FIG. 6).

At 912, the technique 900 involves transmitting data corresponding to the application-specific schedule to a client for display. For instance, schedule data may be transmitted to a client device (e.g., the client device 510 shown in FIG. 5) for display. In some aspects, this step may involve generating a multi-layer schedule display (e.g., the schedule user interface 700 shown in FIG. 7) that allows users to view and interact with different levels of schedule information.

In some implementations, the technique 900 may include additional or fewer steps. For example, the system may employ a third prompt and third LLM to further interpret schedule information (e.g., such as described with respect to schedule interpretation prompt 420 and second large language model 422). In some implementations, a single prompt and single LLM may be utilized (e.g., the standardized schedule may be produced in a single shot approach without separate prompts to interpret legend information, schedule information, or combinations thereof). Technique 900 may include modified or additional steps that perform additional or different actions than described with respect to technique 900, including as described elsewhere in this disclosure, including as previously described with respect to FIGS. 1-8.

References herein to first, second, and third may refer interchangeably or in different orders, depending on the implementation. For example, first, second, and third LLMs are used herein to indicate that different LLMs may be utilized. However, the same LLM may be used for some or all instances of the described LLMs, depending on the implementation.

The technique 900 may also incorporate steps for iterative refinement and validation of the processed schedule. For instance, if the confidence determination indicates insufficient confidence in the interpreted schedule data, the system may initiate a clarification process (e.g., using the obtain clarification 506 shown in FIG. 5). This process may involve generating targeted questions about specific schedule entries or requesting confirmation of candidate schedule characteristics.

In some aspects, the technique 900 may include steps for handling hybrid schedule formats that combine elements of both explicit legend and non-explicit legends. The system may dynamically adjust the prompts utilized based on the specific format encountered, applying different techniques as needed. This flexibility allows the system to accommodate a wide range of scheduling practices across different organizations or departments.

The technique 900 may also incorporate steps for generating multiple output formats from the standardized schedule. For example, the system may be capable of producing machine-readable formats like JSON or XML for integration with other software systems, as well as human-readable formats like PDF or HTML.

In some implementations, the technique 900 may include steps for continuous learning and adaptation. The system may analyze user interactions, corrections, and feedback to refine its interpretation and processing capabilities over time. This may involve updating the language models, adjusting confidence thresholds, or modifying parsing strategies to improve accuracy and efficiency in handling diverse schedule formats.

The technique 900 may also incorporate steps for handling schedules that span across different time zones or include complex recurring patterns. For instance, the system may apply specialized processing to interpret and standardize schedules for global organizations or those with non-standard work cycles. This may involve additional context analysis and pattern recognition to accurately represent and manage such complex scheduling scenarios.

In some aspects, the technique 900 may include steps for integrating external data sources to enhance schedule processing. For example, the system may incorporate information from HR databases, project management tools, or other relevant systems to provide additional context for schedule interpretation. This integration may allow for more accurate and comprehensive schedule processing, considering factors such as employee skills, project timelines, or resource availability.

Some implementations are described below as numbered examples (Example 1, 2, 3, etc.). These examples are provided as examples only and do not limit the other implementations disclosed herein.

According to an aspect of the disclosure, there is provided a method. The method includes receiving a schedule file in a spreadsheet format. The method also includes transmitting a first large language model prompt to a first large language model. The first large language model prompt is configured to cause the first large language model to interpret a legend in the schedule file when processed. The method further includes receiving a first candidate schedule characteristic from processing the first large language model prompt with the first large language model. Additionally, the method involves transmitting a second large language model prompt to a second large language model. The second large language model prompt is based on the schedule and candidate schedule characteristic and is configured to cause the second large language model to generate a standardized schedule conforming to a pre-determined schema that is interpretable by a first application when processed. The method also includes updating an application-specific schedule based on the standardized schedule. Finally, the method involves transmitting data corresponding to the application-specific schedule to a client for display. This method improves the efficiency and accuracy of processing diverse schedule formats by utilizing specialized language models for different aspects of schedule interpretation. Additionally, the method reduces manual effort in standardizing schedules from various sources, enabling seamless integration with existing applications.

In implementations, the method can include transmitting a third large language model prompt to a third large language model. The third large language model prompt is configured to cause the third large language model to identify, within the schedule file, at least one of: a time range of the schedule, shift definition patterns, or user identifiers. The method can also include receiving a second candidate schedule characteristic from processing the third large language model prompt with the third large language model. This additional processing step enhances the comprehensiveness of schedule interpretation by extracting key information that may not be present in the legend. Additionally, it allows for more accurate standardization of complex schedule structures.

In implementations, the first large language model, the second large language model, and third large language model can be implemented by either a single large language model or multiple large language models. These models can be provided by processing the respective large language model on a local computing resource or by invoking an application programming interface to access a hosted large language model provided by a third party. This flexible implementation approach allows for efficient resource utilization and scalability, adapting to the specific needs and constraints of different organizations.

In implementations, the legend in the schedule file can be an explicit legend that identifies at least one of how paid time off is identified in the schedule, shift definitions used in the schedule, and a duration of the schedule. This explicit legend interpretation capability enhances the system's ability to accurately process schedules with varying conventions and notations, reducing errors in schedule standardization.

In implementations, the method can include transmitting a clarification request to a client for display for at least one of the candidate schedule characteristics. The method can also include receiving a clarification response that is used to update the at least one of the candidate schedule characteristics. This interactive clarification process improves the accuracy of schedule interpretation by leveraging human expertise for ambiguous or complex schedule elements.

In implementations, at least one clarification request can be transmitted in response to a determination that an associated at least one candidate schedule characteristic may have been determined incorrectly. This targeted clarification approach enhances the efficiency of the schedule processing by focusing human intervention on potentially problematic areas of interpretation.

In implementations, the method can include interpreting the schedule to identify a second candidate schedule characteristic relating to information included in the schedule that does not correspond to candidate schedule characteristics identified by interpreting the legend. This additional interpretation step allows for comprehensive schedule processing, capturing important information that may not be explicitly defined in the legend.

In implementations, the application-specific schedule can include a plurality of layers. Updating the application-specific schedule based on the standardized schedule can include creating or updating a first layer of the plurality of layers according to the standardized schedule and updating a second layer of the plurality of layers based on the first layer. This multi-layer approach enables flexible and detailed schedule representation, accommodating various levels of schedule complexity and organizational needs.

In implementations, the method can include generating a confidence score for at least the first candidate schedule characteristic. The confidence score indicates a likelihood that the corresponding candidate schedule characteristic has been correctly identified. This confidence scoring mechanism enhances the reliability of the schedule processing system by providing a quantitative measure of interpretation accuracy.

According to an aspect of the disclosure, there is provided a non-transitory computer-readable medium storing instructions. When executed by one or more processors, the instructions cause the one or more processors to perform operations. The operations include receiving a schedule file in a spreadsheet format. The operations also include transmitting a first large language model prompt to a first large language model. The first large language model prompt is configured to cause the first large language model to interpret a legend in the schedule file when processed. The operations further include receiving a first candidate schedule characteristic from processing the first large language model prompt with the first large language model. Additionally, the operations involve transmitting a second large language model prompt to a second large language model. The second large language model prompt is based on the schedule and candidate schedule characteristic and is configured to cause the second large language model to generate a standardized schedule conforming to a pre-determined schema that is interpretable by a first application when processed. The operations also include updating an application-specific schedule based on the standardized schedule. Finally, the operations involve transmitting data corresponding to the application-specific schedule to a client for display. This computer-readable medium enables efficient and accurate processing of diverse schedule formats across different computing environments. Additionally, it facilitates seamless integration of schedule processing capabilities into existing software systems.

In implementations, the operations can further include transmitting a third large language model prompt to a third large language model. The third large language model prompt is configured to cause the third large language model to identify, within the schedule file, at least one of: a time range of the schedule, shift definition patterns, or user identifiers. The operations can also include receiving a second candidate schedule characteristic from processing the third large language model prompt with the third large language model. This additional processing enhances the comprehensiveness of schedule interpretation by extracting key information that may not be present in the legend.

In implementations, the legend in the schedule file can be an explicit legend that identifies at least one of how paid time off is identified in the schedule, shift definitions used in the schedule, and a duration of the schedule. This explicit legend interpretation capability improves the accuracy of processing schedules with varying conventions and notations.

In implementations, the operations can further include transmitting a clarification request to a client for display for at least one of the candidate schedule characteristics. The operations can also include receiving a clarification response that is used to update the at least one of the candidate schedule characteristics. This interactive clarification process enhances the accuracy of schedule interpretation by leveraging human expertise for ambiguous or complex schedule elements.

In implementations, the application-specific schedule can include a plurality of layers. Updating the application-specific schedule based on the standardized schedule can include creating or updating a first layer of the plurality of layers according to the standardized schedule and updating a second layer of the plurality of layers based on the first layer. This multi-layer approach enables flexible and detailed schedule representation, accommodating various levels of schedule complexity and organizational needs.

In implementations, the operations can further include generating a confidence score for at least the first candidate schedule characteristic. The confidence score indicates a likelihood that the first candidate schedule characteristic has been correctly identified. This confidence scoring mechanism enhances the reliability of the schedule processing system by providing a quantitative measure of interpretation accuracy.

According to an aspect of the disclosure, there is provided an apparatus. The apparatus includes one or more processors and memory storing instructions. When executed by the one or more processors, the instructions cause the apparatus to receive a schedule file in a spreadsheet format. The apparatus is also caused to transmit a first large language model prompt to a first large language model. The first large language model prompt is configured to cause the first large language model to interpret a legend in the schedule file when processed. The apparatus is further caused to receive a first candidate schedule characteristic from processing the first large language model prompt with the first large language model. Additionally, the apparatus is caused to transmit a second large language model prompt to a second large language model. The second large language model prompt is based on the schedule and candidate schedule characteristic and is configured to cause the second large language model to generate a standardized schedule conforming to a pre-determined schema that is interpretable by a first application when processed. The apparatus is also caused to update an application-specific schedule based on the standardized schedule. Finally, the apparatus is caused to transmit data corresponding to the application-specific schedule to a client for display. This apparatus provides a dedicated hardware solution for efficient and accurate processing of diverse schedule formats. Additionally, it enables seamless integration of advanced schedule processing capabilities into existing organizational infrastructure.

In implementations, the instructions can further cause the apparatus to transmit a third large language model prompt to a third large language model. The third large language model prompt is configured to cause the third large language model to identify, within the schedule file, at least one of: a time range of the schedule, shift definition patterns, or user identifiers. The instructions can also cause the apparatus to receive a second candidate schedule characteristic from processing the third large language model prompt with the third large language model. This additional processing enhances the comprehensiveness of schedule interpretation by extracting key information that may not be present in the legend.

In implementations, the instructions can further cause the apparatus to transmit a clarification request to a client for display for at least one of the candidate schedule characteristics. The instructions can also cause the apparatus to receive a clarification response that is used to update the at least one of the candidate schedule characteristics. This interactive clarification process improves the accuracy of schedule interpretation by leveraging human expertise for ambiguous or complex schedule elements.

In implementations, the application-specific schedule can include a plurality of layers. Updating the application-specific schedule based on the standardized schedule can include creating or updating a first layer of the plurality of layers according to the standardized schedule and updating a second layer of the plurality of layers based on the first layer. This multi-layer approach enables flexible and detailed schedule representation, accommodating various levels of schedule complexity and organizational needs.

The phrase “in one” embodiment or implementation as used herein does not necessarily refer to the same embodiment or implementation, though it may. Furthermore, the phrase “in another” embodiment or implementation as used herein does not necessarily refer to a different embodiment or implementation, although it may. Thus, as described below, various embodiments or implementations may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C #, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
receiving a schedule file in a spreadsheet format, the schedule file including a schedule;
transmitting a first large language model prompt to a first large language model, the first large language model prompt configured to, when processed by the first large language model, cause the first large language model to interpret a legend in the schedule file;
receiving a first candidate schedule characteristic from processing the first large language model prompt with the first large language model;
transmitting a second large language model prompt to a second large language model, the second large language model prompt is based on the schedule and candidate schedule characteristic and is configured to, when processed by the second large language model, cause the second large language model to generate a standardized schedule conforming to a pre-determined schema that is interpretable by a first application;
updating an application-specific schedule based on the standardized schedule; and
transmitting data corresponding to the application-specific schedule to a client for display.

2. The method of claim 1, further comprising:
transmitting a third large language model prompt to a third large language model, the third large language model prompt configured to, when processed by the third large language model, cause the third large language model to identify, within the schedule file, at least one of:
a time range of the schedule,
shift definition patterns, or
user identifiers; and
receiving a second candidate schedule characteristic from processing the third large language model prompt with the third large language model.

3. The method of claim 2, wherein the first large language model, the second large language model, and third large language model are implemented by either a single large language model or multiple large language models that are provided by processing the respective large language model on a local computing resource or by invoking an application programming interface to access a hosted large language model provided by a third party.

4. The method of claim 1, wherein the legend is an explicit legend that identifies at least one of how paid time off is identified in the schedule, shift definitions used in the schedule, and a duration of the schedule.

5. The method of claim 1, further comprising transmitting a clarification request to a client for display for at least one of the candidate schedule characteristics and receiving a clarification response that is used to update the at least one of the candidate schedule characteristics.

6. The method of claim 5, wherein at least one clarification request is transmitted in response to a determination that an associated at least one candidate schedule characteristic may have been determined incorrectly.

7. The method of claim 1, further comprising interpreting the schedule to identify a second candidate schedule characteristic relating to information included in the schedule that does not correspond to candidate schedule characteristics identified by interpreting the legend.

8. The method of claim 1, wherein the application-specific schedule includes a plurality of layers and updating the application-specific schedule based on the standardized schedule includes creating or updating a first layer of the plurality of layers according to the standardized schedule and updating a second layer of the plurality of layers based on the first layer.

9. The method of claim 8, wherein the standardized schedule includes a schedule of resource unavailability and updating the second layer of the plurality of layers includes excluding resources from the second layer during respective periods of unavailability.

10. The method of claim 1, further comprising generating a confidence score for at least the first candidate schedule characteristic, wherein the confidence score indicates a likelihood that the corresponding candidate schedule characteristic has been correctly identified.

11. A non-transitory computer-readable medium storing instructions that, when executed by one or more processors, cause the one or more processors to perform operations comprising:
receiving a schedule file in a spreadsheet format, the schedule file including a schedule;
transmitting a first large language model prompt to a first large language model, the first large language model prompt configured to, when processed by the first large language model, cause the first large language model to interpret a legend in the schedule file;
receiving a first candidate schedule characteristic from processing the first large language model prompt with the first large language model;
transmitting a second large language model prompt to a second large language model, the second large language model prompt is based on the schedule and candidate schedule characteristic and is configured to, when processed by the second large language model, cause the second large language model to generate a standardized schedule conforming to a pre-determined schema that is interpretable by a first application;
updating an application-specific schedule based on the standardized schedule; and
transmitting data corresponding to the application-specific schedule to a client for display.

12. The non-transitory computer-readable medium of claim 11, wherein the operations further comprise:
transmitting a third large language model prompt to a third large language model, the third large language model prompt configured to, when processed by the third large language model, cause the third large language model to identify, within the schedule file, at least one of:
a time range of the schedule,
shift definition patterns, or
user identifiers; and
receiving a second candidate schedule characteristic from processing the third large language model prompt with the third large language model.

13. The non-transitory computer-readable medium of claim 11, wherein the legend is an explicit legend that identifies at least one of how paid time off is identified in the schedule, shift definitions used in the schedule, and a duration of the schedule.

14. The non-transitory computer-readable medium of claim 11, wherein the operations further comprise transmitting a clarification request to a client for display for at least one of the candidate schedule characteristics and receiving a clarification response that is used to update the at least one of the candidate schedule characteristics.

15. The non-transitory computer-readable medium of claim 11, wherein the application-specific schedule includes a plurality of layers and updating the application-specific schedule based on the standardized schedule includes creating or updating a first layer of the plurality of layers according to the standardized schedule and updating a second layer of the plurality of layers based on the first layer.

16. The non-transitory computer-readable medium of claim 11, wherein the operations further comprise generating a confidence score for at least the first candidate schedule characteristic, wherein the confidence score indicates a likelihood that the first candidate schedule characteristic has been correctly identified.

17. An apparatus comprising:
one or more processors; and
memory storing instructions that, when executed by the one or more processors, cause the apparatus to:
receive a schedule file in a spreadsheet format, the schedule file including a schedule;
transmit a first large language model prompt to a first large language model, the first large language model prompt configured to, when processed by the first large language model, cause the first large language model to interpret a legend in the schedule file;
receive a first candidate schedule characteristic from processing the first large language model prompt with the first large language model;
transmit a second large language model prompt to a second large language model, the second large language model prompt is based on the schedule and candidate schedule characteristic and is configured to, when processed by the second large language model, cause the second large language model to generate a standardized schedule conforming to a pre-determined schema that is interpretable by a first application;
update an application-specific schedule based on the standardized schedule; and
transmit data corresponding to the application-specific schedule to a client for display.

18. The apparatus of claim 17, wherein the instructions further cause the apparatus to:
transmit a third large language model prompt to a third large language model, the third large language model prompt configured to, when processed by the third large language model, cause the third large language model to identify, within the schedule file, at least one of:
a time range of the schedule,
shift definition patterns, or
user identifiers; and
receive a second candidate schedule characteristic from processing the third large language model prompt with the third large language model.

19. The apparatus of claim 17, wherein the instructions further cause the apparatus to transmit a clarification request to a client for display for at least one of the candidate schedule characteristics and receive a clarification response that is used to update the at least one of the candidate schedule characteristics.

20. The apparatus of claim 17, wherein the application-specific schedule includes a plurality of layers and updating the application-specific schedule based on the standardized schedule includes creating or updating a first layer of the plurality of layers according to the standardized schedule and updating a second layer of the plurality of layers based on the first layer.
